(19) United States
(12) Patent Application Publication
(10) Pub. No.: US 2004/0219927 A1
(43) Pub. Date: Nov. 4, 2004

(54) Method and apparatus for locating a mobile transceiver

(76) Inventor: Terence Edward Sumner, Rowlett, TX (US)

Correspondence Address: Terence Edward Sumner, 5201 Panama Drive, Rowlett, TX, 75088, US

(21) Appl. No.: 10/426,778

(22) Filed: Apr. 30, 2003

(51) Int. Cl. H04Q 7/20

(52) U.S. Cl. 455/456.1; 455/456.3

(57) ABSTRACT

A mobile transceiver radio direction-finding sub-system determines the location of a mobile transceiver by receiving information from a locating controller unit that includes tower site geographic location information and radio-frequency protocol information on the target mobile transceiver. After positioning the sub-system within the tower site coverage indicated for the target, the sub-system monitors the target mobile transmitter frequency and utilizes radio direction-finding techniques based on the protocol information to gather bearing and distance information to the target.

### FIELD OF THE INVENTION

This invention relates in general to wireless systems, and more specifically to a method and apparatus for finding the location of a mobile transceiver when it is in range of a communication system.

### BACKGROUND OF THE INVENTION

Modern wireless telephony systems have evolved to provide more than simple voice circuits, including features such as text and graphical displays in the handset to permit users to read and visually receive communications in addition to hearing and speaking. Such systems operate by establishing a connection from a transmitter and/or receiver tower site to the handset or other wireless device. The system is aware of the location of the tower and the frequencies used in the connection.

Popularly, wireless telephone systems are also used to notify police or other emergency agencies of situations and conditions requiring immediate attention, including calls to 9-1-1 service. Mobile wireless telephone handsets and mobile transceivers can be located anywhere in the coverage area for the system of transmitter and receiver tower sites. A responding emergency agency needs to know the exact location of the call in order to direct emergency teams to the location where they are needed. The team can be made aware of the tower site used for the wireless handset, but the granularity available normally is several square miles of coverage. If the caller can describe the location, such as by voice or by the use of an auxiliary locating-device like a GPS add-on, then the team can know exactly where help is needed.

A limitation of prior art location methods for wireless systems has been an inability to determine the exact location of the handset when the caller is unable or unwilling to describe the location. For example, the caller may not know the exact location because he is unfamiliar with the area, or the caller may be hurt and unable to speak. The caller may also be under duress at the time, such as a victim of kidnapping, or even under immediate assault or quietly hiding from his attackers. With the exception of these special cases, 9-1-1 and other operations where location is needed have worked reasonably well for many wireless systems, but do not handle these exceptions well or other cases. Callers are also denied an additional convenience of having services other than emergency ones find them, like taxis looking for a visitor who is unfamiliar with the city or the local area.

Thus, what is needed is a method and apparatus for locating a mobile transceiver in range of a public wireless communication system. Preferably, the method and apparatus will not affect the affect the current operation of the system or device, but will simply be an optional add-on method and device. Changing tower antennas or handset technology or requiring each handset to be equipped with a locating apparatus are all undesirable.

### SUMMARY OF THE INVENTION

An aspect of the present invention is a method in a wireless system for locating a mobile transceiver. The method comprises the step of establishing a communication link session with the transceiver in the normal fashion. This session may have been originated by a caller at the handset itself or from some other point within or outside of the system. The method further comprises the step of determining which transmitter tower site for the link and which frequencies for inbound and outbound portions of the link are in use. The method further comprises substantially delivering the tower site coverage and radio-frequency protocol information to a second wireless transceiver sub-system for use in the proper vicinity of the tower site. The second wireless transceiver sub-system then uses the geographic location of the tower site to assist the operator of the sub-system in getting the sub-system into proper vicinity of the tower site, where radio-direction finding techniques are used in conjunction with the radio-frequency protocol information by the sub-system to pinpoint the location of the first mobile transceiver.

Another aspect of the present invention is a mobile transceiver radio direction-finding sub-system for locating a mobile transmitter-receiver combination (transceiver). The mobile transceiver comprises a link interface for coupling preferably to a communication transceiver, the transceiver being connected via a communication link to a locating controller unit. The sub-system further comprises a processing system coupled to the transceiver interface for processing the information sent from the locating controller unit. The processing comprises determining the current location of the sub-system in relation to the tower site identified in the information, setting up a receiver substantially equivalent to the tower site receiver with the protocol information, and controlling a radio direction-finding antenna on the receiver frequency. The sub-system further comprises a receiver interface for coupling to a communication receiver substantially equivalent to the tower site receiver. In addition, the sub-system comprises a user interface for the operator to control the sub-system and get location information.

Another aspect of the present invention is a locating controller unit for retrieving and delivering radio-frequency protocol information, as well as tower site geographic coverage information, to a mobile transceiver radio direction-finding sub-system. The controller unit comprises a network interface for coupling to a wireless network, such as a wireless telephone network, and a database. A call requesting location services for the handset is coupled from the request interface to the processing system. The processing system requests current tower site and radio-frequency protocol information over the network interface to a wireless network (e.g. MTSO). Retrieved tower site and protocol information are converted into a form usable for an operator of a mobile transceiver radio direction-finding sub-system, and relayed on to the sub-system. The link to the sub-system may be substantially a voice or data connection similar to that of the mobile being sought. If changes in the tower site or protocol information occur, the controller forwards these updates along to the sub-system.

### BRIEF DESCRIPTION OF THE DRAWINGS

FIG. 1 is an electrical block diagram of a wireless system in accordance with the present invention.

FIG. 2 is an electrical block diagram of a mobile transceiver radio direction-finding sub-system in accordance with the present invention.

FIG. 3 is an electrical block diagram of a locating controller unit in accordance with the present invention.

FIG. 4 is a system flow chart in accordance with the present invention.

FIG. 5 is a drawing typifying an antenna suitable for bearing-taking in accordance with the present invention.

### DETAILED DESCRIPTION OF THE DRAWINGS

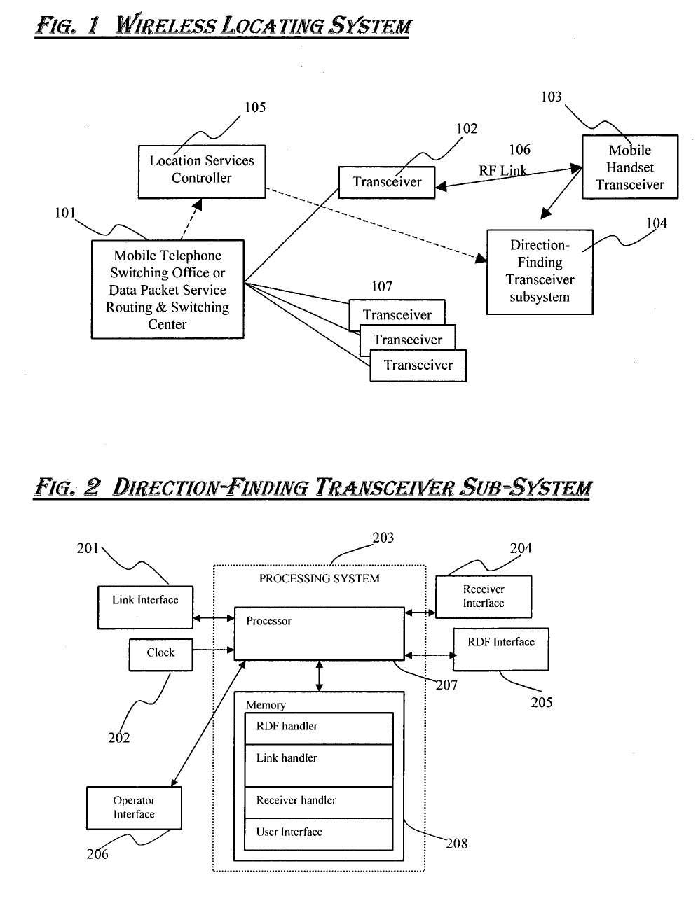

Referring to FIG. 1, an electrical block diagram of a wireless system in accordance with the present invention comprises a mobile telephone switching office (MTSO) 101 providing wireless service to target mobile transceiver 103 through infrastructure transceiver 102 and other transceivers 107. When location of the target transceiver 103 is desired, the MTSO passes tower and channel information about transceiver 102 to the location services controller 105 for subsequent relay to the direction-finding sub-system with transceiver (RDF) 104.

The RDF mobile then adjusts a receiver internal to the sub-system to match the target mobile transmitter. The target mobile transmitter provides the radio-frequency link to the infrastructure transceiver 102. The RDF 104 monitors the transmission according to information received from the location services controller 105. The operator of the mobile RDF 104 may then take bearings to judge the line from the RDF to the target 103. Multiple bearings at different positions will create intersecting lines of bearings, indicating a location of the target.

The RDF mobile 104 may alternatively comprise a receiver for determining its absolute location, such as a GPS receiver, for use with the bearing measurements.

Referring to FIG. 2, an electrical block diagram of a mobile transceiver radio direction-finding sub-system, the memory 208 is pre-programmed with a user interface for the operator, a receiver handler to adjust the operating frequency of the monitoring receiver, a link handler to handle information and commands from the location services controller and provide information back to it, and an optional radio direction-finding handler to control and gather information on the bearings read by the receiver. An operator can manually determine bearings without the RDF interface to adjust bearing or indicate information.

The processing of bearing information and other radio frequency measurements, such as power level, propagation delay relative to known emitters, and power levels of reflections, may be performed at the location services controller or locally at the RDF mobile, whichever may be more advantageous for the situation at hand.

A clock 202 provides timing information for the RDF sub-system processing. A link interface provides input to the processing system from the link connected to the location services controller 105. The link preferably is the same type of connection used in the target mobile or as appropriate for the transfer of data over the types of links available from the infrastructure. An operator interface provides connections or indications to an operator, such as processing system status, power available, and readings of the bearings for a particular target. An indication of the identifier of the target is also desirable. Controls for the operator to operate the RDF bearing and channel in a manual mode are also desirable.

A receiver interface 204 connects to a receive substantially like the receiver in the infrastructure transceiver 102 in that frequencies and formats recognized by the infrastructure can be similarly recognized by the RDF mobile processing sub-system, although providing services like the infrastructure is not necessary. The channel frequency or other modulating characteristics necessary to monitor the target mobile as an infrastructure transceiver 102 or 107 must be modifiable via the interface 204. A preferred monitoring receiver has two or more antenna element inputs allowing phase of the receive emission to be compared among the elements.

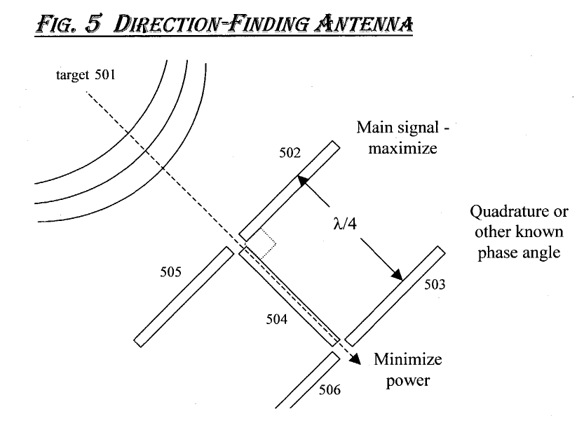

An optional radio direction-finding interface 205 would provide the ability to adjust physical or equivalent parameters of the antenna or other aperture into the transmission medium. If the RDF mobile 104 supports multiple frequency bands, then adjustment of element separation may be required. Readout of bearing information or automatic sweeping of bearings may be effected via the interface 205. Rotation in the horizontal plane would be a good means to adjust the bearing of an antenna, such as that depicted in FIG. 5.

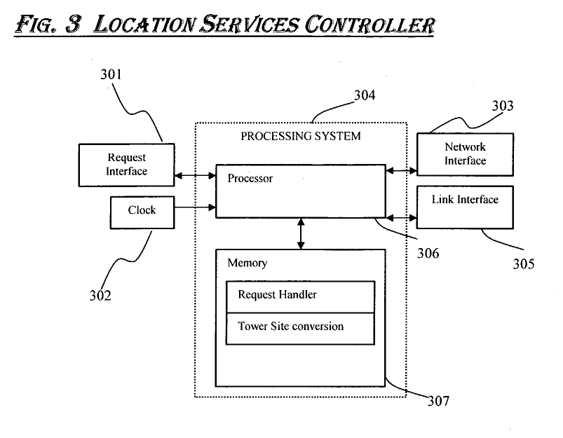

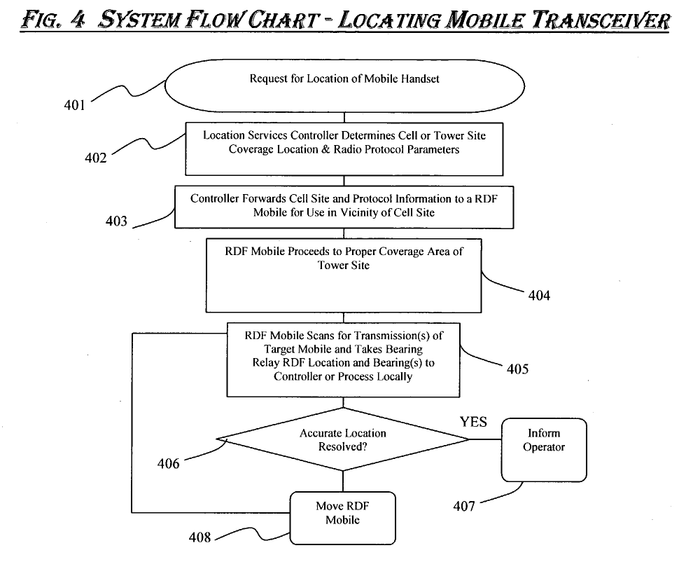

Referring to FIG. 3, an electrical block diagram of a locating controller unit, pre-programmed into memory 307 is a database to convert infrastructure transceiver tower site information into geographic coordinates to aid the operator of the mobile RDF sub-system in arriving in proximity to the location of the coverage from the site from which the target mobile is determined to be by the MTSO 101. Alternatively, a program to convert tower site information into geographic coordinates with the aid of external information received through the network interface 303 is pre-programmed into memory 307. In addition, a request handler is programmed into memory that logically manages requests received via request interface 301 in cooperation with the tower site conversion program. A processor 306 executes the programs and is coupled to a clock 302 that supplies timing signals. The request interface 301 is preferably connected through the switching center or MTSO 101 control signaling sub-system to receive requests originating within the network or passed on by the network. A network interface 303 optionally connects to alternative sources of information to aid in the conversion of tower site information to geographic coordinates.

A link interface 305 passes information either directly to an infrastructure transceiver for linking to the mobile RDF or preferably via the data messaging service provided within the MTSO 101. A broken line indicates the effective path to the RDF mobile 104 in FIG. 1, even though the actual path may be back through the data packet routing center 101.

Referring to FIG. 4, a system flow chart for locating a target mobile transceiver, a request to locate a mobile transceiver or handset begins the process in step 401. In step 402 the location services controller 105 determines the tower site or cell site and coverage location for the target mobile, along with channel and other radio link protocol information, e.g. spreading code, supported air protocol and device-specific information, such as MIN. The determination process may include interrogating an external database, such as a Home Location Register, for this information and other data sources, such as a site geographic coordinate database. The controller 105 in step 403 forwards information derived from the determination process to the mobile RDF for use within a vicinity of the determined tower site. The mobile RDF may be automated or the forwarded information may alert an operator of the mobile RDF to proceed to a location within the proper coverage of the tower site in step 404.

In step 405 the mobile RDF takes repeated angle bearings to the target mobile once the mobile transmissions have been identified. The result of the bearing readings may be processed locally within the RDF sub-system to determine the target location or the location of the RDF along with the result of the bearing readings may be passed to a controller for processing to determine the final location relative to the RDF mobile.

If in step 406 a substantially accurate location can be derived from the information, the operator of the RDF may be informed or the information is simply returned in response to the original request as in step 407. On the other hand, if the position cannot accurately be determined, the mobile must be moved either to another position as in step 408 so that a more discriminating angle can be used to the target or one than is closer and less prone to interference from noise.

Referring to FIG. 5, an antenna comprising a single element 502 is fed into a phase discriminator along with a second antenna element 503 fed into the other input of a phase discriminator in a monitoring receiver connected to receiver interface 204.

The lines of the two elements are separated by a known distance, related to the wavelength of the operating frequency, such as lamba/4 (λ/4), making the phase different by 90 degrees.

As the assembly is rotated in a plane normal to the plane of the source of emission 501 at the operating frequency, the phase changes between the two elements 502 and 503. When the two elements are roughly in alignment toward the source, the RF signals are orthogonal e.g. sin, cos.

A third element 504 is mounted perpendicular to the other two. Since the cosine and sine functions are relatively flat in the region aligning to the source, it is difficult to tell when the parallel elements are pointing exactly at the source. When the end of the perpendicular element points directly at the source, the parallel elements are perfectly aligned normal to the source and the signal on the third element 504 goes to minimum, while the parallel elements 502 and 503 are at maximum (even though flat). The perpendicular element 504 is much more sensitive to misalignment than the parallel elements.

An alternate position 505 for the parallel elements is next to each other end-end. As the wave front, which is nearly flat due to its large diameter, strikes the two elements 502 and 505, the phase difference is minimal when they are exactly normal to the plane of emission from the source 501. A full array of four elements 502 and 505 placed end-end with two more similar elements 503 and 506 placed in the plane separated by the known distance, e.g. λ/4, with the perpendicular element 504 anywhere in the same plane is another effective arrangement.

These and other variations will occur to one of ordinary skill in the art, and are not deemed to depart from the scope of the claimed invention.

Thus, it should be clear from the preceding disclosure that the present invention provides a method and apparatus for locating a mobile handset in a wireless system. Advantageously, the method and apparatus do not affect the current operation of the wireless system components and represent a straight-forward add-on. Changing tower antennas and handset technology are not required.

Many modifications and variations of the present invention are possible in light of the above teachings. Thus, it is to be understood that, within the scope of the appended claims, the invention can be practiced other than as described herein above.

What is claimed is:

1. A method in a wireless system for locating a mobile handset, the method comprising the steps of:
accepting a request for location of a target mobile;
retrieving tower or cell site information from a wireless system;
retrieving handset operating parameters, such as frequency and identifier, from a wireless system;
relaying retrieved information to a radio direction-finding mobile transceiver sub-system;
moving the sub-system to within the coverage area used by the target mobile;
taking antenna bearings and other radio frequency measurements with the sub-system to the target mobile;
processing the measurements to determine a location of the target to a desired accuracy, repeating measurement-taking as needed.

2. A mobile transceiver radio direction-finding unit comprising:
a link interface for coupling to a communication network;
a receiver interface for coupling to receiver substantially equivalent to the receiver at the tower site for monitoring target mobile transmissions;
a radio direction-finding control interface for coupling to an antenna arrangement for taking bearings and other radio frequency parameters on the target transmissions;
a processing system coupled to the link interface for processing location requests, coupled to the receiver interface for controlling the radio frequency parameters of said receiver, coupled to the direction-finding interface for control of taking measurements and receiving said measurements; and
a user interface coupled to the processing system for the operator of the unit to control operations and get information processed by the unit.

3. A location services controller comprising:
a request interface for receiving requests for mobile transceivers;
a network interface for coupling to a wireless network to retrieve cell or tower site coverage information for the target mobile;
a processing system coupled to the request interface and the network interface for processing requests and retrieving information from the wireless network, coupled to a database of coverage information to convert retrieved information into a form suitable for use by a radio direction-finding mobile transceiver unit; and coupled to the link interface to relay processed information to said direction-finding mobile transceiver unit.
